(19) United States
(12) Patent Application Publication
(10) Pub. No.: US 2005/0215194 A1
(43) Pub. Date: Sep. 29, 2005

(54) Combination service request and satellite radio system

(76) Inventors: Brian M. Boling, Knoxville, TN (US); Ronald D. Bishop, Trabucco Canyon, CA (US)

Correspondence Address: LUEDEKA, NEELY & GRAHAM, P.C., P O BOX 1871, KNOXVILLE, TN, 37901, US

(21) Appl. No.: 11/076,488

(22) Filed: Mar. 9, 2005

Related U.S. Application Data
(60) Provisional application No. 60/551,572, filed on Mar. 9, 2004.

(51) Int. Cl. H04B 7/185

(52) U.S. Cl. 455/3.02; 342/357.1; 455/351; 455/348

(57) ABSTRACT

An apparatus and method integrates cellular technology, global positioning system (GPS) technology and satellite radio technology. The components of the apparatus share resources, such as a power, dual GPS/satellite antennae, display screen and controls. The system provides an “on-demand” back channel, such as via the nationwide cellular phone network, that allows a satellite radio subscriber to order data on demand from the satellite radio provider, such as a particular list of songs or travel information. The invention utilizes the existing satellite radio infrastructure which is capable of delivering large amounts of streaming on-demand customized programming and information across a satellite channel to a subscriber's satellite radio decoder. By effectively utilizing the growth and momentum of satellite radio technology, the invention introduces new options for location based services (LBS). Using the existing satellite radio infrastructure minimizes the overall cost of delivery of location based services while allowing a wide range of service options.

This application claims priority to U.S. provisional patent application No. 60/551,572 filed Mar. 9, 2004.

### FIELD OF THE INVENTION

The present invention is generally directed to electronic devices for providing and receiving information. More particularly, the invention is directed to a communication apparatus and method that combines a service request call device and a satellite radio receiver.

### BACKGROUND

In general, satellite radio broadcast services comprise land-based central broadcasting centers that uplink audio programming to privately-owned elliptically-orbiting satellites that deliver the audio programming directly to a customer's receiver. These satellites receive the custom audio programming from the terrestrial-based broadcast center uplink and they downlink the programming on a streaming digital radio frequency signal, such as at 2.3 GHz, to a portable mobile satellite receiver. The receiver decodes the digital signal and outputs an audio signal. The audio signal may be directly amplified and played over speakers, such as when the receiver is used in a boom-box configuration, or transferred via a local RF link to an FM radio in a vehicle, such as when the receiver is used in an in-car configuration. In a typical satellite radio system, the programming content is in the form of voice and music along with textual information that is displayed on a display device, such as an LCD screen. The textual information is typically about the program to which the subscriber is listening.

Currently, there are two companies that offer commercial satellite radio services: Sirius and XM Satellite Radio. The Federal Communication Commission (FCC) has allotted to Sirius the frequency band from 2.320-2.3325 GHz, and to XM the 2.3325-2.345 GHz segment. Sirius operates three satellites with about 100 terrestrial repeaters and XM operates two satellites with about 1,100 repeaters. Sirius has assigned orbital slots of the three satellites at 68-90 degrees inclination, so they have direct line of site to the top of a mobile unit almost anywhere in the United States. XM's two satellites transmit from a relatively low angle of between 30-35 degrees. In order to gain nationwide coverage, XM has installed the large terrestrial repeater network in an attempt to obtain a nationwide coverage footprint. At this time, the XM network does not provide repeaters in towns of less than 300,000 population, and it does not have repeater networks in most rural or mountainous areas.

Although satellite radio service providers have the capability of streaming large quantities of audio information to their subscribers, there is no mechanism available allowing the subscribers to communicate with the service providers to request particular information services at a particular time. What is needed therefore, is a system that provides radio satellite subscribers the ability to request desired information services and enables delivery of the requested services.

### SUMMARY OF THE INVENTION

The above and other needs are met by an apparatus and method for providing two-way communication between a satellite radio subscriber and an on-demand information service request center. Preferred embodiments of the apparatus and method integrate cellular technology, global positioning system (GPS) technology and satellite radio technology. Components of the apparatus share resources, such as a power, dual GPS/satellite antennae, display screen and controls. The system provides an “on-demand” back channel, such as via the nationwide cellular phone network, that allows a satellite radio subscriber to order on-demand information services from the satellite radio service provider, such as navigation information or a particular list of songs. The invention preferably utilizes the existing satellite radio infrastructure with its capability of delivering streaming on-demand programming and information across a satellite channel to the subscriber's satellite radio decoder. The invention effectively utilizes the growth and potential of satellite radio technology to introduce new options for on-demand location based services (LBS). By using the existing satellite radio infrastructure, the invention minimizes the overall cost of delivery of location based services while allowing a wide range of service options.

In a preferred embodiment, the invention provides a communication system for receiving satellite radio signals from one or more satellite radio service satellites and providing audio programming derived from the satellite radio signals to a subscriber. In this embodiment, the communication system includes a satellite radio communication unit comprising a satellite radio tuner, a position determination receiver and a dual-use antenna that is electrically coupled to the satellite radio tuner and the position determination receiver. The satellite radio tuner decodes the satellite radio signals to generate audio signals and provides the audio signals to an audio sound system. The position determination receiver receives position determination signals from position determination system satellites, such as GPS satellites, and generates position coordinate signals based on the position determination signals. The dual-use antenna receives the satellite radio signals from the satellite radio service satellites and provides the satellite radio signals to the satellite radio tuner. The dual-use antenna also receives the position determination signals from the position determination system satellites and provides the position determination signals to the position determination receiver.

In some preferred embodiments, the communication system includes a wireless communication unit for generating service request signals and transmitting the service request signals to a service request call center by way of a wireless communication network. The wireless communication unit receives the position coordinate signals from the position determination receiver and generates the service request signals based at least in part on the position coordinate signals. The wireless communication unit may function according to a number of different communication protocols, including Dual Tone Multi-frequency (DTMF), Code-Division Multiple Access (CDMA), Time-Division Multiple Access (TDMA), Global System for Mobile Communications (GSM), personal communications service (PCS) and Blue Tooth.

Preferred embodiments of the invention also include the service request call center and the satellite radio service provider. Among other things, the service request call center receives the service request signals from the wireless communication unit, generates requested information signals based at least in part on the service request signals, and formats the requested information signals for transmission over a data network. The satellite radio service provider receives the requested information signals from the data network, determines the content of the satellite radio signals based at least in part on the requested information signals, and uplinks the satellite radio signals to the satellite radio service satellites.

In some preferred embodiments, the satellite radio communication unit includes a cradle unit having a housing for receiving and holding a removable satellite radio tuner unit. The cradle unit includes a power connector for receiving power from a power supply, a satellite radio signal connector for receiving the satellite radio signals from the dual-use antenna, a position signal connector for receiving the position determination signals from the dual-use antenna, and a cradle interface connector. The satellite radio tuner unit includes a cradle interface connector that mates with the cradle interface connector in the cradle. Through the cradle interface connectors, the satellite radio tuner unit receives power and the satellite radio signals. In these embodiments of the invention, the position determination receiver is disposed within the housing of the cradle unit and is electrically connected to the position signal connector for receiving the position determination signals.

In another aspect, the invention provides a method for providing on-demand information services to an information service subscriber via a mobile communication unit, where the mobile communication unit is in communication with a wireless communication network and a satellite radio system. In a preferred embodiment, the method includes steps of (a) establishing a communication session between the mobile communication unit and a service request call center over the wireless communication network, (b) transmitting identification information from the mobile communication unit to the service request call center, where the identification information identifies a particular mobile communication unit associated with a particular subscriber, (c) transmitting a request for information services from the mobile communication unit to the service request call center, (d) communicating the request from the service request call center to the satellite radio service provider, and (e) transmitting the requested information from the satellite radio service provider to the mobile communication unit via satellite, where the content of the requested information is based at least in part on the request from the subscriber.

In a preferred embodiment, the method includes transmitting position information from the mobile communication unit to the service request call center, where the position information indicates a position of the mobile communication unit. A request for navigation information is transmitted from the mobile communication unit to the service request call center. The requested navigation information, which is determined based at least in part on the position information transmitted from the mobile communication unit, is communicated from the service request call center to the satellite radio service provider. The requested navigation information is then transmitted from the satellite radio service provider to the mobile communication unit via the satellite radio system. The requested navigation information is loaded into memory in the mobile communication unit, formatted for display, and displayed on a display device associated with the mobile communication unit.

In another preferred embodiment, the method includes displaying a list of on-demand information options on a display device associated with the mobile communication unit. These on-demand information options may include, but is not limited to, travel information, weather information, navigation information and on-demand musical selections. One or more of the on-demand information options are selected by the subscriber using a selection device associated with the mobile communication unit, and selection information is generated that indicates the selected information option. The selection information is transmitted from the mobile communication unit to the service request call center, and is communicated from the service request call center to the satellite radio service provider. The satellite radio service provider then transmits the information requested by the subscriber to the mobile communication unit via the satellite radio system.

In yet another aspect, the invention provides a method for sending audio information to an audio information service subscriber via a satellite radio system. The method includes providing audio programming to a mobile communication unit by way of the satellite radio system. The audio programming, such as streaming digital audio, includes sequential audio program files that are played on an audio system associated with the mobile communication unit. While listening to the audio programming, the subscriber may select one or more of the audio program files played on the audio system using a selection device associated with the mobile communication unit. This generates selection information indicating which of the audio program files are selected, and the selection information is stored in memory associated with the mobile communication unit. At some time thereafter, a communication session is established over a wireless communication link between the mobile communication unit and a service request center. The selection information is then transmitted from the mobile communication unit to the service request center over the wireless communication link. Based on the selection information, selected audio program files are acquired from one or more distribution entities that distribute audio program files. The selected audio program files are compiled into a desired delivery format and delivered to the subscriber.

In one embodiment, the selected audio program files are recorded on a portable storage medium, such as a compact disk, which is delivered to an address provided by the subscriber. In another embodiment, the selected audio program files are stored on a storage device accessible to the subscriber via a data communication network, such as the Internet. The selected audio program files may then be downloaded from the storage device to the subscriber's computer or digital audio device via the data communication network.

### BRIEF DESCRIPTION OF THE DRAWINGS

Further advantages of the invention will become apparent by reference to the detailed description of preferred embodiments when considered in conjunction with the drawings, which are not to scale, wherein like reference characters designate like or similar elements throughout the several drawings as follows:

FIG. 1 depicts a satellite radio system for use in a vehicle;

FIG. 2 depicts a functional block diagram of a GPS-enabled satellite radio system for providing on-demand location based services according to a preferred embodiment of the invention;

FIG. 3 depicts a call center for receiving and processing requests for location based services according to a preferred embodiment of the invention;

FIG. 4 depicts a flnctional block diagram of a GPS-enabled satellite radio system for providing on-demand location based services according to an alternative embodiment of the invention;

FIG. 5 depicts a satellite radio tuner unit according to a preferred embodiment of the invention;

FIG. 6 depicts a functional block diagram of a satellite radio tuner unit according to a preferred embodiment of the invention;

FIGS. 7A and 7B depict a GPS-enabled satellite radio tuner unit according to an alternative embodiment of the invention;

FIG. 8 depicts a system for transferring audio data to a WIFI-enabled satellite radio tuner according to a preferred embodiment of the invention;

FIG. 9 depicts a method for requesting navigation information according to a preferred embodiment of the invention;

FIG. 10 depicts a method for requesting on-demand music and information according to a preferred embodiment of the invention;

FIG. 11 depicts a method for selecting and purchasing music according to a preferred embodiment of the invention; and

FIG. 12 depicts a method for receiving hotel information and reserving a hotel room according to a preferred embodiment of the invention.

### DETAILED DESCRIPTION OF THE INVENTION

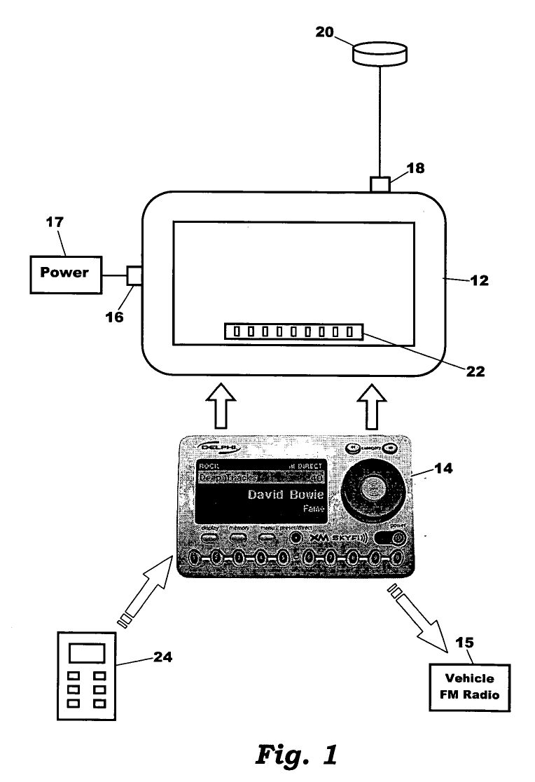

An example of a satellite radio receiver configuration 10 for a vehicle is shown in FIG. 1 This configuration 10 includes a cradle 12 having a slot or recess for receiving a detachable tuner unit 14. The cradle 12 has a power connector 16 for receiving 12 VDC vehicle power and an antenna connector 18 that connects to an antenna 20 for receiving satellite signals. Within the recess in the cradle 12 is a connector 22 that connects the tuner unit 14 to the vehicle power and the satellite antenna. The tuner unit 14 may include an infrared (IR) receiver that allows the user to send programming commands via an IR remote control unit 24. The tuner unit 14 typically has a low-power FM transmitter for transmitting the audio programming from the tuner unit 14 to the FM radio 15 in the vehicle.

Every satellite radio tuner has a unique electronic serial number (ESN) stored in memory within the tuner unit. Using the ESN in an identification string, a satellite radio service provider can transmit customized messages via satellite to a particular tuner unit. These tuner-specific messages are usually transmitted in the blind types of the satellite transmission, such that no acknowledgement from the satellite receiver is expected. For example, when activating a particular tuner unit for a new subscriber, the satellite service provider sends transmissions with activation commands that are specific to that tuner. Typically, activation takes place instantly upon transmission of the activation commands so that the subscriber can immediately begin receiving the streaming program channels. According to the present invention, this capability of the satellite service provider to transmit messages to specific tuner unit can be expanded into many different types of service offerings for the satellite radio subscriber.

Generally, the satellite radio tuner unit 14 may be used in other installation configurations. For example, the tuner unit 14 may be inserted into a cradle within a stereo boom box or into a cradle in a home stereo component. Thus, it should be appreciated that the invention is not limited to any particular type of installation for the tuner unit 14.

In one aspect, the invention integrates GPS technology into the satellite radio architecture so that location-based services (LBS) and associated accessories can be offered to a subscriber as part of the satellite radio service package. In another aspect, the invention provides a feedback mechanism to allow the satellite radio subscriber to send service request messages to a customer service call center. By integrating the GPS function with the service request function, preferred embodiments of the invention provide satellite radio subscribers the ability to request and receive location-based “on-demand” information services.

The “on demand” service categories include navigation information such as turn-by-turn driving instructions, travel information including locations of restaurants, hotels and fuel, homeland security information, local traffic information including road conditions (accidents, detours, closures), local weather information and weather alerts, financial information including stock portfolio updates, and industry-specific information, such as for truckers or delivery personnel. The “on demand” services may also include emergency response services (police, fire, ambulance), purchasing services with electronic coupons for hotels, fueling locations, restaurants, campgrounds and golf courses, text message delivery such as using Short Message Service (SMS), live operator third-party call connect services, vehicle web tracking, family member web tracking, home/office PC-to-mobile data downloads, regional map downloads, stolen vehicle recovery services, music on demand and books on demand.

In one embodiment of the invention, existing in-vehicle cradle units can be modified to include GPS functionality. For example, in existing cradle units a GPS access cover can be removed to reveal a slot into which a printed circuit “daughter” board having an external GPS connector can be inserted. A GPS unit with a mating connector is then connected to the daughter board, thereby making the cradle unit 12 operable to support GPS location determination functions. When a GPS unit running constantly, it can provide a stream of x/y coordinate data in National Marine Electronics Association (NMEA) format that can be used for LBS accessories. When a satellite receiver unit is modified to include GPS functionality, the cost to add accessories that give the subscriber access to location based services is much less than the cost of conventional LBS solutions. This is because the power, antennae and GPS engine is already present in the satellite radio unit.

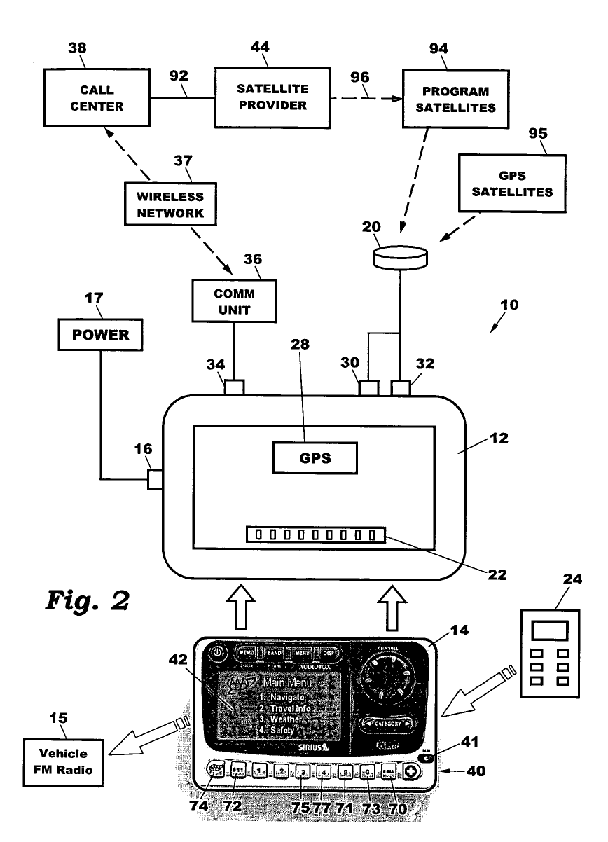

FIG. 2 depicts a preferred embodiment of a satellite radio unit 10 wherein the cradle 12 includes a GPS unit 28. This embodiment takes advantage of shared system resources. In particular, the satellite antenna system 20 is used for receiving GPS satellite signals and satellite radio signals. Also, the GPS unit 28 receives power from the same power source 17 as does the rest of the satellite radio system. The cradle 12 and tuner unit 14 of this embodiment comprise a fully functional satellite radio system providing all of the services that are typically offered by a satellite radio service provider with the added capability of producing NMEA/GPS location data.

In the embodiment of FIG. 2, the satellite antenna 20 comprises a broadband element that operates efficiently in both the 1.5 GHz band for GPS signals and the 2.3 GHz band for satellite radio signals. The antenna 20 preferably has two antenna connectors 30 and 32, such as automotive Sumitomo connectors as are typically used in automobile applications. The connector 30 is used for the GPS connection and the connector 32 for the satellite radio connection. The cradle 12 has two corresponding mating connectors for the satellite radio and GPS signals.

As shown in FIG. 2, the cradle 12 preferably includes a communication interface connector 24, such as a 20-pin Universal Data and Two-Way Radio Communications bus (U-BUS) connector, which provides connectivity to a series of peripheral devices. The U-BUS connector 34 provides two-way communication between the cradle 12 and an external two-way wireless communication unit 36. In the preferred embodiment, the U-BUS 34 provides the primary power for the communication unit 36 and the two-way data link from the GPS unit 28 to the communication unit 36.

The communication unit 36 could be any one of a number of wireless devices, such as a mobile data terminal, a Blue Tooth device, a DTMF analog cellular transceiver, a CDMA cellular transceiver with modem, a TDMA cellular transceiver with modem, a GSM cellular transceiver with modem, a PCS cellular transceiver with modem, a dual band transceiver with modem/DSP/DTMF/cellular overhead or a VHF/UHF radio transceiver. In one preferred embodiment, the communication unit 36 is a CDMA2000 card manufactured by AnyData Corporation of Irvine, Calif. Thus, it should be appreciated that the communication unit 36 of the invention is not limited to any particular type of device.

As shown in FIG. 2, the communication unit 36 formats the GPS data and transmits the data via a wireless network 37 to a service request call center 38. The call center 38, such as the Procon, Inc. Universal Call Center in San Diego, Calif., incorporates a front-end communications interface that is flexible enough to accommodate communication protocols from any of the above-listed types of communication unit 36. The flexibility of the GPS-enabled satellite radio unit 10 to interface to a variety of types of communication unit 36 using various data and voice communications protocols enables access to a wide variety of location based services.

For example, via the U-BUS 34, the satellite radio unit 10 can interface with a local Mobile Data Terminal having a full map display showing the location of the unit 10 and select points of interest nearby. As another example, the unit 10 can send the NEMA/GPS data via the U-BUS 34 to a Blue Tooth capable cellular handset that transmits the location information to the call center 38. By interfacing via the U-BUS 34 with any type of cellular communication unit 36, a user can send location data to the call center 38 and request assistance via an automatic voice connection.

As shown in FIG. 2, the preferred embodiment of the tuner unit 14 includes LBS buttons 40 which allow the user to select several types of location based services, such as emergency roadside assistance, local weather conditions, emergency police/fire/medical assistance, turn-by-turn driving directions provided by live operator sessions or by a Mobile Data Terminal map display, text messaging to the display 42 of the tuner unit 14, Internet vehicle tracking, and stolen vehicle recovery services. Additionally, the invention provides for communication with the call center 38 to locate nearby gas stations, repair facilities, food, overnight accommodations, and to receive detour and traffic notifications.

Preferably, the display 42 on the tuner unit 14 is a color LCD screen which is at least a 5.6 inch diagonal to provide the best viewing of map graphics and text data. The screen 42 is preferably sunlight-readable and viewable from different angles. Large fonts and easily understood icons are also preferably used.

The ability of the satellite radio service provider 44 to send one-way messages via the satellites 94 to particular units 10 anywhere in the country provides a platform for a variety of services. In concert with the satellite radio service provider 44, the call center 38 provides nationwide two-way full duplex communication links to transport data and voice to selected satellite radio units 10. The combination of resources of the satellite service provider 44 and the call center 38 provides a very unique and efficient form of message delivery for location based services. The addition of modular GPS and two-way communication components to satellite radio products is also quite cost effective.

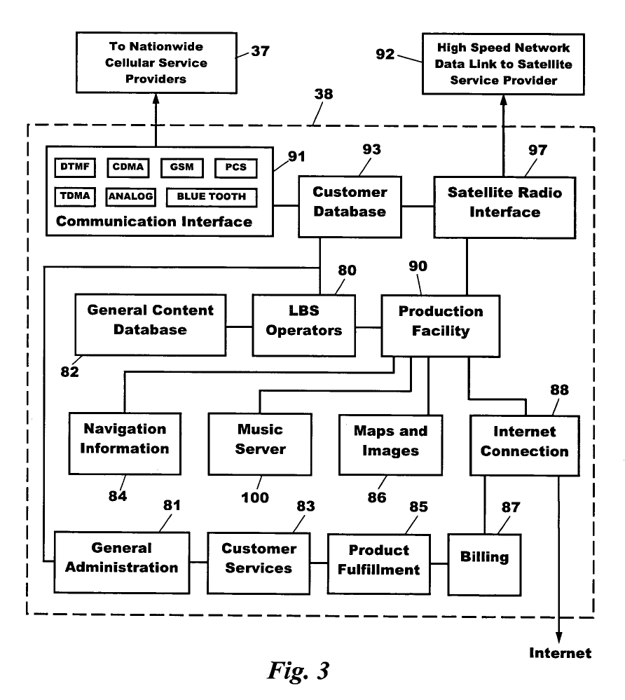

A block diagram of a preferred embodiment of the call center 38 is shown in FIG. 3. The call center 38 includes a communication interface 91 having the capability of interfacing with various types of communication devices using various protocols. These protocols include but are not limited to DTMF, CDMA, GSM, PCS, TDMA, analog and Blue Tooth. The customer database 93 contains information regarding all customers that have subscribed to the call center services. The satellite radio interface 97 is the communication interface to the high-speed network connecting the call center 38 to the satellite radio service provider 44. The general content database 82 preferably includes information on weather, traffic, hotels, restaurants, fuel centers, emergency roadside assistance and other such information often needed by users of the mobile satellite radio unit 10. The LBS operators 80 include the operator terminals and software used in providing two-way voice communication between live operators and subscribers. The production facility 90 receives requested data from various information sources and formats the data into data packages that may be efficiently transferred to the satellite radio service provider 44. Those information sources preferably include a navigation information module 84, a music server 100, a maps and images server 86 and an Internet connection. The call center 38 also includes a general administration module 81, a customer services module 83, a product fulfillment module 85 and a billing module 87.

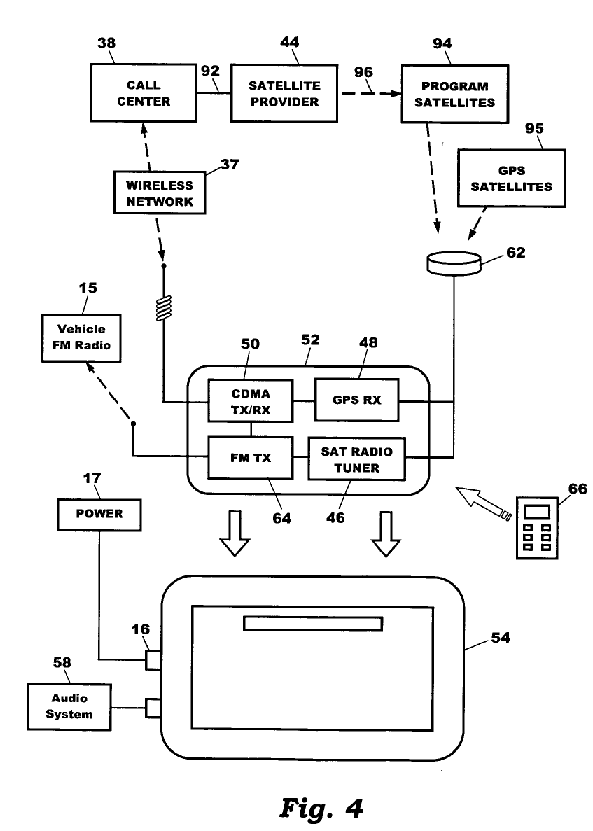

Shown in FIG. 4 is an embodiment of the invention wherein a satellite radio tuner 46, a GPS receiver unit 48 and a cellular transceiver 50 are integrated into a portable satellite radio unit 52. In this embodiment, the unit 52 includes a communication and power bus connector that provides for connecting the unit 52 to a plug-in cradle 54. In one preferred embodiment, the cradle 54 is configured for installation in a vehicle wherein it provides connections to the vehicle power supply 17 and audio/speaker system 58. In another preferred embodiment, the cradle 54 is configured for in-home use wherein it provides connections to the home power supply 17 and an in-home audio/speaker system 58. In these preferred embodiments, the satellite radio tuner 46, GPS unit 48 and cellular transceiver 50 share the same power source, and the satellite radio tuner 46 and GPS unit 48 share the same broad-band antenna system 62. The embodiment of FIG. 4 also includes an IR remote control unit 66 used to control both the satellite tuner functions and the cellular calling functions.

As shown in FIG. 4, a preferred embodiment includes a low-power FM radio transmitter 64 interfaced with the cellular transceiver module 50 and the satellite radio tuner 46. This provides for hands-free cellular two-way voice communication using the vehicle's standard FM radio 15. The FM transmitter 64 also transmits the satellite radio audio signal to the vehicle's FM radio 15. A software or firmware interrupt scheme allows the satellite radio tuner 46 and cellular transmitter 50 to share the FM transmitter 64. By using the FM transmitter 64 of the portable unit 52, cellular hands-free calls may be made using the full audio power of the vehicle's FM radio system 15. This eliminates the need for a separate speaker having less audio quality than that of the vehicle's FM radio system 15.

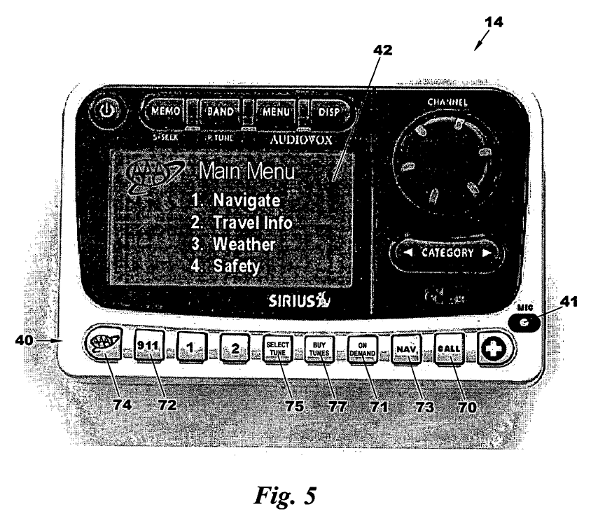

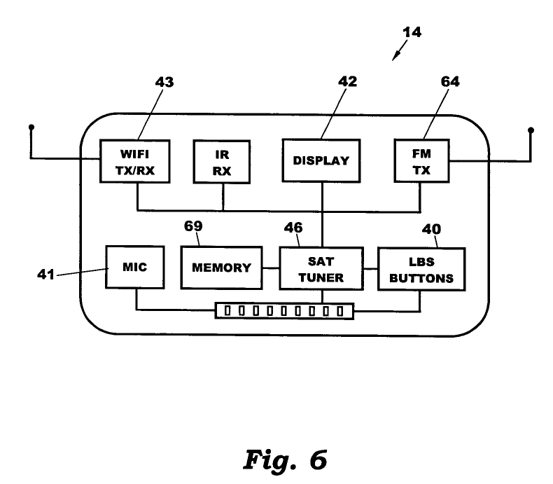

FIGS. 5 and 6 depict one preferred embodiment of a portable satellite radio unit 14. This embodiment of the portable unit 14 includes call control buttons 40 used to command specific calling features. For example, the buttons 40 include a “CALL” button 70 for initiating normal voice and data calls, an emergency “911” button 72 for initiating voice calls to emergency response services and a “AAA” button 74 for initiating emergency roadside service voice calls. Other of the buttons 68 may be programmed for travel information calls and weather information calls.

Preferably, a satellite radio subscriber can switch between streaming audio or hands-free phone functions by simply using the standard satellite radio channel selection process. For example, as shown in FIG. 5, additional channels are included in the main menu of satellite radio channel selections, such as the “Navigate”, “Weather” and “Travel Info”.

The satellite radio unit 52 preferably includes a significant amount of onboard memory 69 so that detailed regional mapping data may be downloaded from the satellite service provider to the unit 52. For example, local map display data may be downloaded to unit 52 for use during a particular communication session with the satellite service provider wherein the driving directions are provided. After such a session, the local map data may be deleted from memory 69 to make room for other information. Alternatively, or in addition, a nationwide mapping database may be stored in long-term memory within the unit 52.

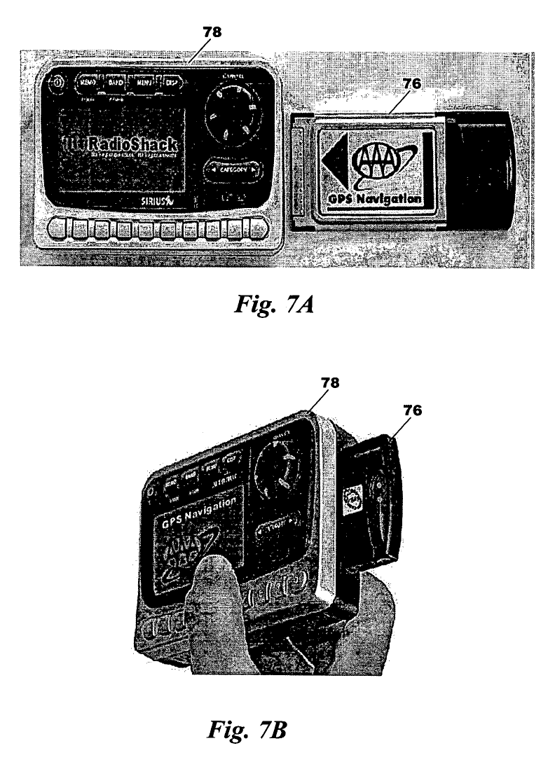

FIGS. 7A and 7B depict a packaging configuration for an embodiment of the invention wherein a GPS receiver and CDMA cellular transceiver are integrated into a card 76 that plugs into a slot in the housing of a satellite tuner unit 78. In this embodiment, GPS and cellular antennas are packaged in the portion of the card 76 that extends outside the housing of the unit 78. The extending portion of the card 76 also preferably includes power and transmit indication LED's.

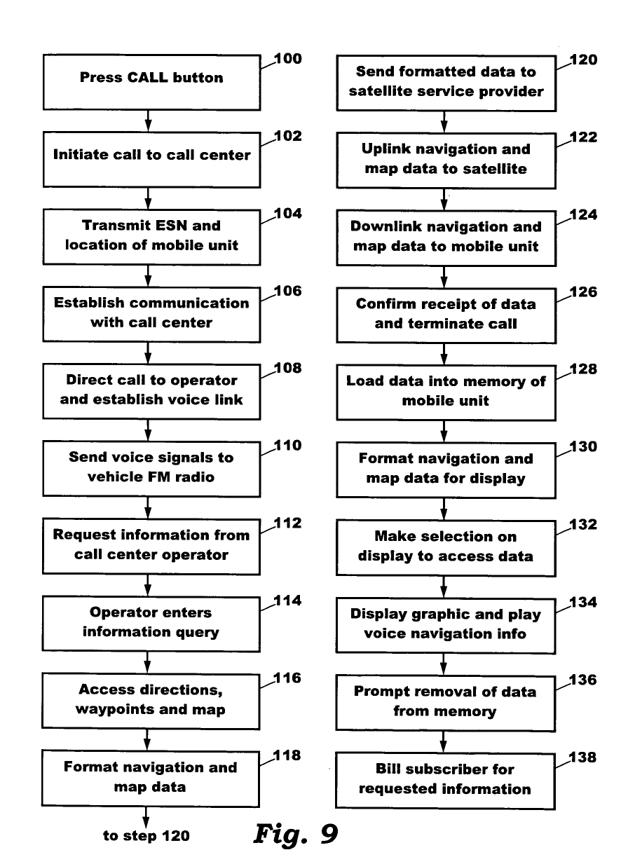

With reference to FIGS. 2, 3, 5, 6 and 9, a preferred method of communication between the satellite radio unit 10, the call center 38 and the satellite provider 44 includes the following steps. The satellite radio subscriber initiates a call to the call center 38 by pressing the “CALL” button 70 on the satellite radio tuner unit 14 (step 100 in FIG. 7). The communication unit 36, which in this example is a CDMA cellular transceiver, automatically calls and establishes communication with the call center 38 via the wireless network 37 (FIG. 2)(step 102).

Once communication is established, the communication unit 36 provides the ESN of the tuner unit 14 for identification purposes and GPS location data indicating the current location of the tuner unit 14 (step 104). Calls from the communication unit 36 are directed to a specific Dialed Number Identification Service (DINIS) in the call center 38 that automatically initiates the two-way communication protocols with the modem in the communication unit 37 to determine the identification and location of the unit 10 (step 106). In this example, the modem uses a communication protocol such as Short Messaging Service (SMS) to send data to and receive data from the call center 38.

At the call center 38, the call is directed to an LBS operator 80 and a voice link is established between the subscriber and the LBS operator 80 (FIG. 3)(step 108). Preferably, both the voice and data links are assigned to an available operator position. The LBS operator 80 will have full access to the subscriber's information stored in the customer database 93, including the ESN of the mobile unit 10.

At the mobile unit 10, the FM transmitter 64 in the tuner unit 14 sends the hands-free voice signal to the vehicle FM radio 56 (step 110). The subscriber requests driving directions to a particular restaurant (step 112). The operator 80 enters the name of the restaurant into a designated field on the operator's screen, and the location of the restaurant is determined from the general content database 82 at the call center 38 (step 114). Based on the location, the navigation information module 84 determines turn-by-turn driving directions, designates X-Y waypoints along the route, and pulls a map of the route from the maps and images database 86 (step 116). In the preferred embodiment, the waypoints designate points along the route at which the map graphics will be updated on the display 42 of the tuner unit 14 and at which vocal directions for the next segment of the route will be played.

The navigation and mapping information are formatted into data packages in the production facility 90 (step 118). The data packages, which are tagged with the ESN of the tuner unit 14, are sent to the satellite service provider 44 via a high-speed data network 92 (step 120). The satellite service provider 44 receives the data packages and sends the data to one or more of the satellites 94 via a radio-frequency uplink 96 (step 122). The satellite 94 sends to the data packages to the mobile unit 10 having the corresponding ESN via a radio frequency (2.3 Ghz) downlink 98 (step 124). Preferably, voice communication is maintained between the subscriber and the LBS operator 80 during this time.

When the data transfer to the mobile unit 10 is complete, the subscriber confirms with the LBS operator 80 that the information was received at which time the call may be terminated (step 126). The received data is loaded into the onboard memory 69 in the tuner unit 14 (step 128). A data formatting module running in the processor of the satellite tuner 46 accesses the received data from memory, formats the mapping data and the turn-by-turn driving directions to be displayed on the tuner's display screen 42 (step 130). Alternatively, or in addition, the turn-by-turn driving directions may be stored in memory 69 in one or more audio data files, such as “WAV” files.

After termination of the call to the call center 38, the subscriber accesses the turn-by-turn direction information and mapping information by selecting the “Navigate” option on the display 42 of the tuner unit 14 (FIG. 5)(step 132). In the preferred embodiment of the invention, the NMEA interface of the GPS engine 28 is running in concert with the navigation program and is generating XY location coordinates as the vehicle travels along the route. When an inserted waypoint is detected and the XY location coordinate from the GPS engine 28 matches that waypoint, the screen graphic and voice directions for the next portion of the route are presented to the subscriber (step 134). In the preferred embodiment, the turn-by-turn driving instructions are displayed as scrolling or pop-up text on the display 42 immediately above or below a map image that provides a complete geo-overview of the route from beginning to end. Preferably, compass headings with turn-to directions are also provided for clarity. The voice instructions are played over the FM radio of the vehicle audio system 56.

When the subscriber arrives at the destination, the mobile unit 10 provides visual and audio cues to the subscriber to erase the most recent instructions download in order to make room in the onboard memory 69 for other features (step 136).

In a preferred embodiment, the call center 38 bills the subscriber's credit card for the transaction and makes distributions to partner business entities (step 138).

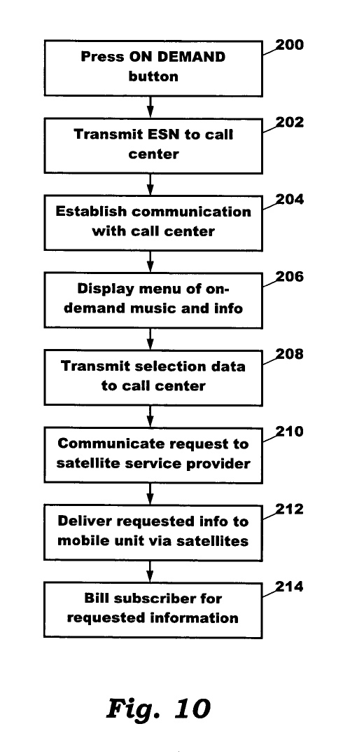

With reference to FIGS. 2, 3, 5, 6 and 10, another preferred method of communication between the satellite radio unit 10, the call center 38 and the satellite provider 44 includes the following steps. The subscriber presses the “On Demand” button 71 on the tuner unit 14 (step 200). The mobile unit's ESN is transmitted to the call center 38 via the wireless network 37 (step 202). Two-way communication is established between the call center 38 and the mobile unit 10 (step 204). A menu of on-demand music and information is displayed on the display screen 42 (step 206). The subscriber makes a selection from the menu and selection data is transmitted via the wireless network 37 to the call center (step 208). The call center 38 processes the order and communicates the order to the satellite radio provider 44 via the high-speed data network 92 (step 210). The satellite radio provider processes the order and delivers the requested music or other information in data packets via the uplink 96 and the satellites 94 to the mobile unit 10 (step 212). The call center 38 bills the subscriber's credit card for the transaction and makes distributions to partner business entities (step 214).

With reference to FIGS. 2, 3, 5, 6 and 11, a method of communication between the satellite radio unit 10, the call center 38 and the satellite provider 44 which allows the subscriber to select and purchase music includes the following steps. In this example, the subscriber is listening to streaming music using the satellite radio unit 10 and hears a song that the subscriber would like to purchase (step 300). While the song is playing, the subscriber presses a “Select Tune” button 75 on the tuner unit 14 to bookmark their purchase selection (step 302). Information from the satellite radio streaming data that identifies the song title and artist is stored in a song list, or album, in the on-board memory 69 of the tuner unit 14 (step 304).

In one preferred embodiment, the on-board memory 69 will accommodate about 67.5 megabytes of a downloaded data in an MP3 format, which is equivalent to about 20 songs. This is about the same number of songs in wave file format that will normally fit on a 640-megabyte compact disc (CD). A firmware program in the tuner unit 14 alerts the subscriber via a message on the display 42 when the number of songs in the list would fill a CD album (step 306). This message indicates it is time to transmit the list of selections to the call center 38. The subscriber presses the “Buy Tunes” button 77 and the data file containing the list of selected tunes stored in the memory 69 is transmitted to the call center 38 via the communication unit 36 and cellular network 37 (step 308). The ESN of the mobile unit 10 is also transmitted with the list of tunes. The ESN and list of tunes are received by the call center 38 where they are stored on a storage device accessible to the music server 100 (step 310).

The music server 100 (FIG. 6) accesses the list and begins requesting bids over the Internet from sources that sell music, such as Apple's i-Tunes, Fast Atmosphere, Inc., RealNetworks, Inc., Roxio, Inc., Napster Music, Inc., Vivendi Universal SA and PepsiCo, Inc. (step 312). The music sources server 100 executes the purchase and download of the selection of songs, such as in MP3 file format, (step 314) and compiles the song files into a file format for transmission to the subscriber (step 316). The call center 38 sends a notice to the subscriber that the requested album of songs is ready to be downloaded (step 318). This notice may be delivered by way of a CDMA/SMS session through the communication unit 36, a satellite radio downlink message through the satellite service provider 44, an e-mail message or a phone call.

The subscriber can elect to have the album of songs delivered (step 320) using any one of several different methods. The album file may be downloaded directly to the mobile unit tuner unit 14 via the satellite radio downlink and stored in the on-board memory 69. Any or all of the song files may then be transferred from the tuner unit 14 to the subscriber's PC or other music storage device via an RF transceiver 43 such as over a WiFi link, or via a wired interface such as a Universal Serial Bus (USB) or an Ethernet connection. The album file may also be downloaded from the call center 38 via the Internet to the subscriber's PC or other music storage device. Alternatively, the call center 38 could have the album file transferred to a CD which is delivered to the subscriber via a package carrier service.

WiFi services are generally available at many restaurants, hotels, airports, libraries, and hundreds of other locations nationwide. WiFi connectivity can be implemented on a laptop computer using a PCMCIA WiFi card and a wireless router with an Internet connection. Several companies manufacture WiFi products designed to facilitate the on-line purchase and downloading of music to home stereo equipment and auto sound systems.

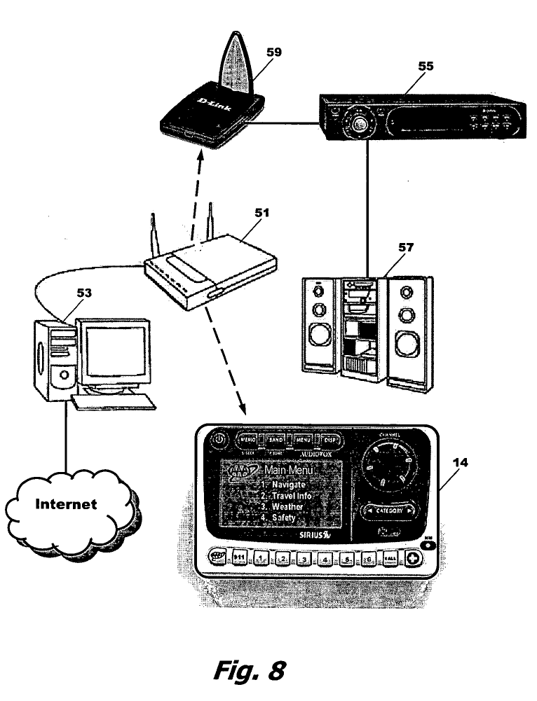

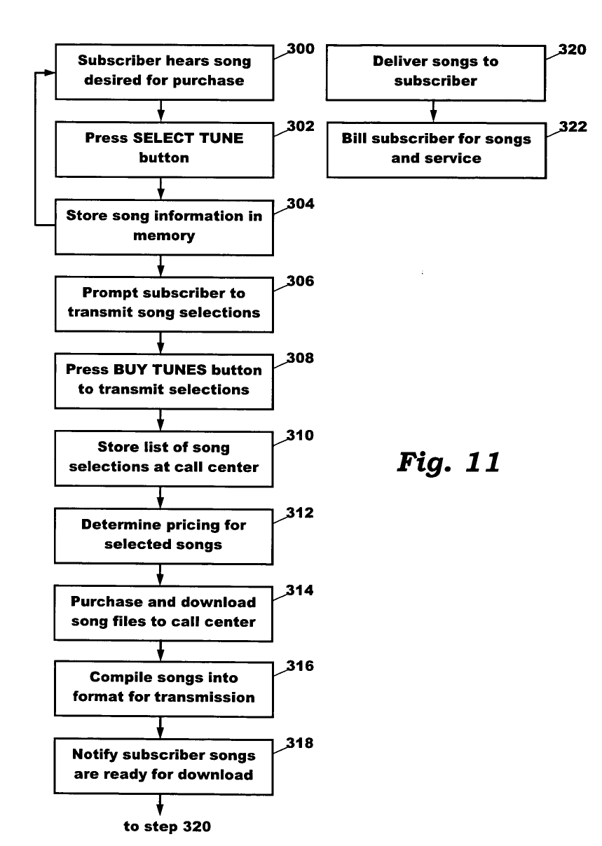

FIG. 8 depicts an example of a system that uses a wireless router 51 to transfer audio programming to the transceiver 43 (FIG. 6) in the mobile satellite radio tuner unit 14. The system may also be used to transfer audio programming via a wireless adapter 59 to a home digital audio receiver 55 connected to a home audio system 57. With this system, music purchased using the method of FIG. 11 may be received on the subscriber's home computer 53 via the Internet and then transferred to the satellite tuner 14 or to the home audio system 57.

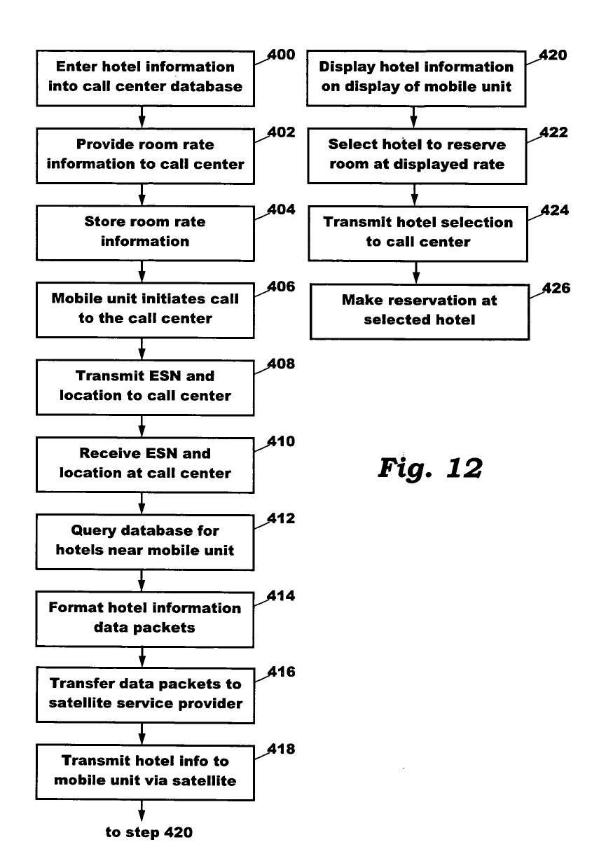

With reference to FIGS. 2, 3, 5, 6 and 12, a preferred embodiment of the invention provides a method of communication between the satellite radio unit 10, the call center 38 and the satellite provider 44 to enable a subscriber to request and receive hotel rate information for nearby hotels. At the call center 38, location coordinates of all hotels participating in this service offering have been entered into a database (step 400). In the following example, a manager of a participating hotel in San Diego determines that a number of rooms are available at a reduced rate for a certain period of time. The hotel manager contacts the call center 38 to provide information regarding the rooms and rate (step 402). This information may be provided in any number of ways, including by way of a voice call to an operator at the call center 38, a credit card transaction terminal, facsimile or email. In one preferred embodiment of the invention, the information provided includes a hotel identification number, a manger/employee number, the reduced room rate being offered, the start date and time of the offer and a transaction identification code. This information is entered into a temporary data file in a database at the call center 38 (step 404).

In this example, a subscriber is traveling in a vehicle on an overnight trip to San Diego and is seeking convenient and reasonably priced hotel accommodations. The subscriber initiates a call to the call center 38 by selecting “Hotel Information” from a menu on the display 42 of the mobile unit 10 (step 406). Depending on the configuration of the mobile unit 10, this call could also be initiated by pressing a dedicated button on the mobile unit 10. The mobile unit 10 transmits to the call center 38 the ESN of the tuner unit 14, the current location coordinates of the mobile unit 10 and the direction of travel of the mobile unit 10 via the wireless network 37 (step 408).

The call center 38 receives the ESN and the location and direction information (step 410) and queries the database for participating hotels that are within a certain radius of the mobile unit's location (step 412). The call center 38 then formats the hotel information into data packets, such as including the names and locations of the hotels and any reduced rates that are being offering (step 414). The data packets are then sent to the satellite service provider 44 via the high-speed data network 92 (step 416). The satellite service provider 44 uplinks the hotel data to the satellites 94 which downlink the data to the mobile unit 10 (step 418). Alternatively, the hotel data is transmitted to the mobile unit via the wireless network 37.

A listing of the hotel information is then displayed on the display 42 of the tuner unit 14 (step 420). In a preferred embodiment of the invention, the subscriber selects one of the listed hotels to reserve a room at the stated rate by highlighting the name of the hotel on the display 42 and pressing a SELECT button on the mobile unit 10 (422). This selection is then transmitted via the communication unit 36 and the wireless network 37 to the call center 38 (step 424). The call center 38 receives the selection information and communicates with the selected hotel to make the reservation for the subscriber (step 426). Once the reservation is complete, the call center 38 sends a confirmation message to the subscriber, either by way of the satellite provider 44 or directly over the wireless network 37.

Although the previous example was directed to hotel information, it should be appreciated that this method is applicable to many types of products, services and attractions. For example, the database at the call center 38 may include rate/price and location information for fuel service companies, food establishments, campgrounds, golf courses and major attractions.

It is contemplated, and will be apparent to those skilled in the art from the preceding description and the accompanying drawings that modifications and/or changes may be made in the embodiments of the invention. Accordingly, it is expressly intended that the foregoing description and the accompanying drawings are illustrative of preferred embodiments only, not limiting thereto, and that the true spirit and scope of the present invention be determined by reference to the appended claims.

1. A communication system for receiving satellite radio signals from one or more audio program service satellites and providing audio programming derived from the satellite radio signals to a subscriber, the communication system comprising: a satellite radio communication unit comprising:
a satellite radio tuner unit for decoding the satellite radio signals to generate audio signals and for providing the audio signals to an audio sound system;
a position determination receiver for receiving position determination signals from position determination system satellites and for generating position coordinate signals based on the position determination signals; and
a dual-use antenna electrically coupled to the satellite radio tuner and the position determination receiver, the dual-use antenna for receiving the satellite radio signals from the audio program service satellites and the position determination signals from the position determination system satellites and for providing the satellite radio signals to the satellite radio tuner unit and providing the position determination signals to the position determination receiver.

2. The communication system of claim 1 wherein the satellite radio communication unit further comprises:
the satellite radio tuner unit having a first cradle interface connector for receiving a power signal and the satellite radio signals;
a cradle unit comprising a housing for receiving and removably holding the satellite radio tuner unit, the cradle unit further comprising:
a power connector for receiving the power signal from a power supply;
a satellite radio signal connector for receiving the satellite radio signals from the dual-use antenna;
a position signal connector for receiving the position determination signals from the dual-use antenna; and
a second cradle interface connector for connecting to the first cradle interface connector and providing the power signal and the satellite radio signals to the first cradle interface connector; and
the position determination receiver disposed within the housing of the cradle unit and electrically connected to the position signal connector for receiving the position determination signals.

3. The communication system of claim 1 further comprising a wireless communication unit for generating service request signals and transmitting the service request signals to a service request call center by way of a wireless communication network.

4. The communication system of claim 3 wherein the wireless communication unit receives the position coordinate signals from the position determination receiver and generates the service request signals based at least in part on the position coordinate signals.

5. The communication system of claim 3 further comprising the service request call center for receiving the service request signals from the wireless communication unit, for generating requested information signals based at least in part on the service request signals and for formatting the requested information signals for transmission over a data network.

6. The communication system of claim 5 further comprising a satellite radio service provider for receiving the requested information signals from the data network, for determining content of the satellite radio signals based at least in part on the requested information signals and for uplinking the satellite radio signals to the audio program service satellites.

7. The communication system of claim 2 wherein
the cradle unit further comprises a communication interface connector for receiving at least the power signal and the position coordinate signals; and
the satellite radio communication unit further comprises a wireless communication unit connected to the communication interface connector, the wireless communication unit for receiving the power signal and the position coordinate signals from the communication interface connector and for transmitting service request signals by way of a wireless communication network to a service request call center.

8. The communication system of claim 3 wherein
the satellite tuner unit further comprises a microphone electrically connected to the wireless communication unit, and
the wireless communication unit generates the service request signals comprising two-way voice communication signals whereby two-way voice communication may be established between the service request call center and the satellite radio communication unit.

9. The communication system of claim 3 wherein the satellite radio communication unit further comprises a portable housing, and wherein the satellite radio tuner unit, the position determination receiver, and the wireless communication unit are disposed within the housing.

10. The communication system of claim 3 wherein the wireless communication unit transmits the service request signals according to a communication protocol selected from the group consisting of Dual Tone Multi-frequency (DTMF), Code-Division Multiple Access (CDMA), Time-Division Multiple Access (TDMA), Global System for Mobile Communications (GSM), personal communications service (PCS) and Blue Tooth.

11. A satellite radio communication unit for receiving satellite radio signals from a satellite radio system, the satellite radio communication unit comprising:
a removable card unit comprising:
a position determination receiver for receiving position determination signals from position determination system satellites and for generating position coordinate signals based on the position determination signals; and
a wireless communication unit for generating service request signals and transmitting the service request signals to a service request call center by way of a wireless communication network;
a portable housing having a slot receptacle for receiving the removable card unit; and
a satellite radio tuner unit disposed in the portable housing, the satellite radio tuner unit for decoding the satellite radio signals to generate audio signals and for providing the audio signals to an audio sound system.

12. A method for providing on-demand information services to an information service subscriber via a mobile communication unit in communication with a wireless communication network and a satellite radio system, the method comprising:
(a) establishing a communication session between the mobile communication unit and a service request call center over the wireless communication network;
(b) transmitting identification information from the mobile communication unit to the service request call center, where the identification information identifies a particular mobile communication unit associated with a particular subscriber;
(c) transmitting a request for information services from the mobile communication unit to the service request call center;
(d) communicating the request from the service request call center to the satellite radio service provider; and
(e) transmitting requested information from the satellite radio service provider to the mobile communication unit via satellite, where the content of the requested information is based at least in part on the request.

13. The method of claim 12 further comprising:
(f) transmitting position information from the mobile communication unit to the service request call center, where the position information indicates a position of the mobile communication unit;
step (c) comprising transmitting a request for navigation information from the mobile communication unit to the service request call center,
step (d) comprising communicating requested navigation information from the service request call center to the satellite radio service provider, where the requested navigation information is based at least in part on the position information transmitted from the mobile communication unit,
step (e) comprising transmitting the requested navigation information from the satellite radio service provider to the mobile communication unit via the satellite radio system;
(g) loading the requested navigation information into memory in the mobile communication unit;
(h) formatting the requested navigation information for display on a display device associated with the mobile communication unit; and
(i) displaying the requested navigation information on the display device.

14. The method of claim 13 wherein step (i) further comprises displaying a map on the display device.

15. The method of claim 13 wherein step (i) further comprises displaying turn-by-turn driving directions on the display device.

16. The method of claim 13 further comprising:
step (e) comprising transmitting audio navigation information from the satellite radio service provider to the mobile communication unit via the satellite radio system; and
(i) playing the audio navigation information on an audio system associated with the mobile communication unit.

17. The method of claim 12 further comprising
(f) displaying a list of on-demand information options on a display device associated with the mobile communication unit;
(g) selecting one or more of the on-demand information options using a selection device associated with the mobile communication unit and generating selection information indicating the selected on-demand information option;
step (c) comprising transmitting the selection information from the mobile communication unit to the service request call center;
step (d) comprising communicating the selection information from the service request call center to the satellite radio service provider; and
step (e) comprising transmitting selected information indicated by the selected on-demand information option from the satellite radio service provider to the mobile communication unit via the satellite radio system.

18. The method of claim 17 further comprising:
step (f) comprising displaying a menu of music options on the display device;
step (g) comprising selecting one or more of the music options using the selection device;
step (e) comprising transmitting selected audio information indicated by the selected music option from the satellite radio service provider to the mobile communication unit via the satellite radio system; and
(h) playing the selected audio information on an audio system associated with the mobile communication unit.

19. The method of claim 12 further comprising:
(f) maintaining a hotel information database accessible to the service request call center, the hotel information database including hotel room rate information;
(g) transmitting position information from the mobile communication unit to the service request call center, the position information indicating a position of the mobile communication unit;
step (c) further comprising transmitting a request for hotel information from the mobile communication unit to the service request call center;
(h) querying the hotel information database to determine hotel information based at least in part on the position information, the hotel information including hotel selection options;
step (d) further comprising communicating the hotel information from the service request call center to the satellite radio service provider;
step (e) further comprising transmitting the hotel information from the satellite radio service provider to the mobile communication unit via satellite;
(i) displaying the hotel information including the hotel selection options on a display device associated with the mobile communication unit;
(j) selecting a hotel from the hotel selection options using a selection device associated with the mobile communication unit, and generating hotel selection information based on the hotel selection;
(k) transmitting the hotel selection information from the mobile communication unit to the service request call center; and
(l) communicating a reservation request to the selected hotel from the service request call center.

20. A method for providing audio information to an audio information service subscriber via a satellite radio system, the method comprising:
(a) providing audio programming by way of the satellite radio system to a mobile communication unit, the audio programming including sequential audio program files;
(b) playing the audio program files on an audio system associated with the mobile communication unit;
(c) selecting one or more of the audio program files played on the audio system using a selection device associated with the mobile communication unit, and generating selection information indicating the one or more selected audio program files,
(d) storing the selection information in memory associated with the mobile communication unit;
(e) establishing a communication session between the mobile communication unit and a service request center over a wireless communication network;
(f) transmitting the selection information from the mobile communication unit to the service request center over the wireless communication system;
(g) based on the selection information, acquiring the selected audio program files from one or more distribution entities that distribute audio program files;
(h) compiling the selected audio program files into a delivery format to be delivered to the subscriber; and
(i) delivering the selected audio program files to the subscriber in the delivery format.

21. The method of claim 20 wherein
step (a) further comprises providing streaming audio from the satellite radio system to the mobile communication unit, where the streaming audio includes musical selections,
step (c) further comprises selecting a musical selection as it is played on the audio system by pressing a selection button on the mobile communication unit,
step (d) further comprises storing a list of musical selections in the memory, and
step (g) further comprises determining prices charged by the distribution entities for purchase of the musical selections.

22. The method of claim 20 wherein
step (h) further comprises recording the selected audio program files on a portable storage medium, and
step (i) further comprises delivering the portable storage medium to an address provided by the subscriber.

23. The method of claim 20 wherein
step (h) further comprises storing the selected audio program files on a storage device accessible to the subscriber via a data communication network, and
step (i) further comprises downloading the selected audio program files from the storage device to the subscriber via the data communication network.

24. The method of claim 20 further comprising prompting the subscriber to establish the communication session between the mobile communication unit and the service request center when it is determined that the selected audio program files would occupy a predetermined amount of storage space.
